(19) United States
(12) Patent Application Publication
(10) Pub. No.: US 2025/0070211 A1
(43) Pub. Date: Feb. 27, 2025

(54) STACK OF SOEC/SOFC SOLID OXIDE CELLS HAVING INNER GUIDING ELEMENTS

(71) Applicant: COMMISSARIAT A L'ENERGIE ATOMIQUE ET AUX ENERGIES ALTERNATIVES, Paris (FR)

(72) Inventors: Olivier GILLIA, Grenoble Cedex 09 (FR); Mathieu MONTEREMAND, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/728,963

(22) PCT Filed: Jan. 12, 2023
(86) PCT No.: PCT/FR2023/050043

§ 371 Date: Jul. 15, 2024

(30) Foreign Application Priority Data
Jan. 17, 2022 (FR) FR2200369

(51) Int. Cl. H01M 8/2432; C25B 9/77; C25B 13/02; H01M 8/0256; H01M 8/12; H01M 8/2404

(52) U.S. Cl. CPC H01M 8/2432; C25B 9/77; C25B 13/02; H01M 8/0256; H01M 8/2404; H01M 2008/1293

(57) ABSTRACT

A stack of SOEC/SOFC solid oxide cells includes a plurality of stacked plates and two guiding elements ensuring that the vertical stacking of at least some of the plates is guided, each plate having two guiding orifices. In a cross-sectional view, the guiding orifices are aligned in a first horizontal direction and are spaced apart by a smaller inter-orifice distance, the guiding elements being spaced apart by a greater smaller inter-element distance and the difference corresponding to the identical inner clearance for the two guiding orifices. The guiding orifices are spaced apart by a larger inter-orifice distance and the guiding elements are spaced apart by a shorter larger inter-element distance, the difference corresponding to the outer clearance, which is greater than the inner clearance.

### TECHNICAL FIELD

The present invention relates to the general field of high-temperature electrolysis (HTE), in particular high-temperature steam electrolysis (HTSE), respectively referred to by the English names “High-Temperature Electrolysis” (HTE) and “High-Temperature Steam Electrolysis” (HTSE), carbon dioxide (CO₂) electrolysis, or steam and carbon dioxide (CO₂) high-temperature co-electrolysis.

More specifically, the invention relates to the field of high-temperature solid-oxide electrolysers, usually referred to by the acronym SOEC (standing for “Solid-Oxide Electrolysis Cell” in English).

It also relates to the field of high-temperature solid-oxide fuel cells, usually referred to by the acronym SOFC (standing for “Solid-Oxide Fuel Cells” in English).

Thus, more generally, the invention relates to the field of SOEC/SOFC-type solid-oxide stacks operating at high temperature.

More specifically, the invention relates to a SOEC/SOFC-type solid-oxide cells stack comprising inner guiding elements, as well as an associated conditioning process.

### PRIOR ART

In the context of a SOEC-type high-temperature solid-oxide electrolyser, steam (H₂O) is transformed into dihydrogen (H₂) and dioxygen (O₂), and/or carbon dioxide (CO₂) is transformed into carbon monoxide (CO) and dioxygen (O₂) by means of an electric current, within the same electrochemical device. In the context of a SOFC-type high-temperature solid-oxide fuel cell, the operation is reversed to produce an electric current and heat by being supplied with dihydrogen (H₂) or other fuels such as methane (CH₄), natural gas, biogas, and dioxygen (O₂), for example dioxygen contained in the air. For simplicity, the following description favours the operation of a SOEC-type high-temperature solid-oxide electrolyser carrying out the electrolysis of steam. Nonetheless, this operation is applicable to the electrolysis of carbon dioxide (CO₂), or to the co-electrolysis of steam at high temperature with carbon dioxide (CO₂). In addition, this operation can be transposed to the case of a SOFC-type high-temperature solid-oxide fuel cell.

In order to carry out the electrolysis of water, it is advantageous to carry it out at high temperature, typically between 600 and 1,000° C., because it is more advantageous to electrolyse steam than liquid water and because part of the energy necessary for the reaction could be supplied by heat, less expensive than electricity.

To implement the high-temperature steam electrolysis (HTSE), a SOEC-type high-temperature solid-oxide electrolyser consists of a stack of elementary units each including a solid-oxide electrolysis cell, or an electrochemical cell, consisting of three anode/electrolyte/cathode layers superposed on top of one another, and interconnection plates made of metal alloys, also called bipolar plates or interconnectors. Each electrochemical cell is sandwiched between two interconnection plates. A SOEC-type high-temperature solid-oxide electrolyser is then an alternating stack of electrochemical cells and interconnectors. A SOFC-type high-temperature solid-oxide fuel cell consists of the same type of stack of elementary units. This high-temperature technology being reversible, the same stack can operate in the electrolysis mode and produce hydrogen and oxygen from water and electricity, or in the fuel cell mode and produce electricity from hydrogen and oxygen.

Each electrochemical cell corresponds to an electrolyte/electrode assembly, which is typically a multilayer assembly, wherein the electrolyte is formed by an ion-conducting central layer, this layer being solid, dense and sealed, and sandwiched between the two porous layers forming the electrodes. It should be noted that additional layers may exist, but which only serve to improve one or more of the layers already described.

The electrical and fluidic interconnection devices are electronic conductors which ensure, from an electrical viewpoint, the connection of each elementary unit electrochemical cell in the stack of elementary units, guaranteeing electrical contact between one face and the cathode of a cell and between the other face and the anode of the next cell, and from a fluidic viewpoint, the supply of reagents and the discharge of the products for each of the cells. Thus, the interconnectors ensure the functions of supplying and collecting an electrical current and delimit gas circulation compartments, for distribution and/or collection.

More specifically, the main function of the interconnectors is to ensure the passage of the electric current but also the circulation of the gases in the vicinity of each cell (namely: injected steam, hydrogen and oxygen extracted for the HTE electrolysis; air and fuel including the injected hydrogen and extracted water for a SOFC cell), and to separate the anode and cathode compartments of two adjacent cells, which are the gas circulation compartments on the side of the anodes and cathodes of the cells, respectively.

In particular, for a SOEC-type high-temperature solid-oxide electrolyser, the cathode compartment includes steam and hydrogen, produced from the electrochemical reaction, whereas the anode compartment includes a draining gas, if present, and oxygen, another product of the electrochemical reaction. For a SOFC-type high-temperature solid-oxide fuel cell, the anode compartment includes the fuel, whereas the cathode compartment includes the fuel.

To carry out the high-temperature steam electrolysis (HTE), steam (H₂O) is injected into the cathode compartment. Under the effect of the electric current applied to the cell, the dissociation of the water molecules in the form of steam is carried out at the interface between the hydrogen electrode (cathode) and the electrolyte: this dissociation produces dihydrogen gas (H₂) and oxygen ions (O²⁻). The dihydrogen (H₂) is collected and discharged at the outlet of the hydrogen compartment. The oxygen ions (O²⁻) migrate through the electrolyte and recombine into dioxygen (O₂) at the interface between the electrolyte and the oxygen electrode (anode). A draining gas, such as air, can circulate at the anode and thus collect the oxygen generated in gaseous form at the anode.

To ensure the operation of a solid-oxide fuel cell (SOFC), air (oxygen) is injected into the cathode compartment of the cell and hydrogen into the anode compartment. The oxygen of the air will dissociate into O²⁻ ions. These ions will migrate in the electrolyte from the cathode towards the anode to oxidise the hydrogen and form water with simultaneous production of electricity. In an SOFC cell, like in a SOEC electrolysis, the steam is in the dihydrogen compartment (H₂). Only the polarity is reversed.

For illustration, FIG. 1 shows a schematic view showing the operating principle of a SOEC-type high-temperature solid-oxide electrolyser. The function of such an electrolyser is to transform steam into hydrogen and oxygen according to the following electrochemical reaction:

2H₂O→2H₂+O₂.

This reaction is carried out electrochemically in the cells of the electrolyser. As schematically shown in FIG. 1, each elementary electrolysis cell 1 is formed of a cathode 2 and an anode 4, placed on either side of a solid electrolyte 3. The two electrodes (cathode and anode) 2 and 4 are electronic and/or ionic conductors, made of a porous material, and the electrolyte 3 is gas-tight, an electronic insulator and an ion conductor. In particular, the electrolyte 3 may be an anionic conductor, more specifically an anionic conductor of the O²⁻ ions and the electrolyser is then so-called an anionic electrolyser, in contrast with proton electrolytes (H⁺).

The electrochemical reactions take place at the interface between each of the electronic conductors and the ionic conductor.

At the cathode 2, the half-reaction is as follows:

2H₂O+4e⁻→2H₂+2²⁻

At the anode 4, the half-reaction is as follows:

2O²⁻→O₂+4e⁻.

The electrolyte 3, interposed between the two electrodes 2 and 4, is the site of migration of the O²⁻ ions under the effect of the electric field created by the potential difference imposed between the anode 4 and the cathode 2.

As illustrated between brackets in FIG. 1, the steam at the cathode inlet may be accompanied by hydrogen H₂ and the hydrogen produced and recovered at the outlet may be accompanied by steam. Similarly, as illustrated in dotted lines, a draining gas, such as air, may also be injected at the anode-side inlet to discharge the produced oxygen. An additional function of the injection of a draining gas is to act as a thermal regulator.

An elementary electrolyser, or electrolysis reactor, consists of an elementary cell as described hereinabove, with a cathode 2, an electrolyte 3, and an anode 4, and two interconnectors which ensure the electrical and fluidic distribution functions.

To increase the flow rates of produced hydrogen and oxygen, it is known to stack several elementary electrolysis cells on top of one another while separating them by interconnectors. The assembly is positioned between two end interconnection plates which support the electric power supplies and the gas supplies of the electrolyser (electrolysis reactor).

Thus, a SOEC type high-temperature solid-oxide electrolyser comprises at least one, generally several, electrolysis cell(s) stacked on top of one another, each elementary cell being formed of an electrolyte, a cathode and an anode, the electrolyte being interposed between the anode and the cathode.

As indicated before, the fluidic and electrical interconnection devices which are in electrical contact with one or more electrode(s) generally ensure the electric current supply and collection functions and delimit one or more gas circulation compartment(s).

Thus, the function of the so-called cathode compartment is the distribution of the electric current and of the steam as well as the recovery of hydrogen at the cathode in contact.

The function of the so-called anode compartment is the distribution of the electric current as well as the recovery of the oxygen produced at the anode in contact, possibly with the help of a draining gas.

FIG. 2 shows an exploded view of elementary units of a SOEC-type high-temperature solid-oxide electrolyser according to the prior art. This electrolyser includes a plurality of elementary electrolysis cells C1, C2, of the solid-oxide cell (SOEC) type, stacked alternately with interconnectors 5. Each cell C1, C2 consists of a cathode 2.1, 2.2 and of an anode (only the anode 4.2 of the cell C2 is shown), between which an electrolyte is arranged (only the electrolyte 3.2 of the cell C2 is shown).

The interconnector 5 is a component made of a metal alloy which ensures separation between the cathode 50 and anode 51 compartments, defined by the volumes comprised between the interconnector 5 and the adjacent cathode 2.1 and between the interconnector 5 and the adjacent anode 4.2, respectively. It also ensures the distribution of the gases to the cells. The injection of steam into each elementary unit is done in the cathode compartment 50. The collection of the produced hydrogen and of the residual steam at the cathode 2.1, 2.2 is performed in the cathode compartment 50 downstream of the cell C1, C2 after dissociation of the steam by the latter. The collection of the oxygen produced at the anode 4.2 is performed in the anode compartment 51 downstream of the cell C1, C2 after dissociation of the steam by the latter. The interconnector 5 ensures the passage of the current between the cells C1 and C2 by direct contact with the adjacent electrodes, i.e. between the anode 4.2 and the cathode 2.1.

In order to guarantee good electrical contact between all of the interconnectors, the electrochemical cells and the interconnectors are sandwiched between two rigid plates, so-called the upper end plate and the lower end plate, electrically isolated from the interconnectors. The sandwich thus formed is so-called “stack”, and thus corresponds to the assembly comprising the upper and lower end plates, the electrochemical cells and the interconnectors. This stack should be kept under a compressive force to ensure good electrical continuity of the contact planes between the plates.

During the first phase of manufacture of the stacks, it is proceeded with the formation of the vitroceramic seal by subjecting the stack to a thermal cycle while applying a controlled compressive force on the stack. This thermal cycle is called the conditioning cycle.

Indeed, the various sealings between the circuits are ensured by seals made of molten glass. This molten glass is obtained by deposition of slip, a glass precursor. The slip is deposited in the form of beads sandwiched between the interconnection plates (or interconnectors). Afterwards, this slip dries in place to create a bead made of glass powder supplemented with organic binders. Thus, when cold, before the temperature rise cycle which will form the glass, the interconnection plates are separated by dried slip beads. These beads will melt down during the heating cycle, and the contacts will be established at the previously-described reactive areas. Melting of the beads may result in a reduction of the thickness of the slip bead by more than 50%. These beads may also be made of already densified glass, sandwiched between two successive interconnectors of the stack. Just like during the conditioning cycle with dried slip beads, the meltdown of the glass seal will cause the shrinkage of the space between the interconnectors, but to a lesser extent than with slip.

In any case, it is important to ensure guidance according to a direction perpendicular to the plane of the interconnectors, or collinear with the direction of the compressive force of the interconnection plates and of the end plates. Such guidance allows guaranteeing that, during the shrinkage of the stack, which occurs during the formation of the glass, the constituent parts of the stack (in particular the interconnectors, the insulating plates, the end plates) remain correctly aligned with respect to one another. During this phase, the height of the stack decreases by practically 50% and thus results in a considerable vertical movement of the stack.

The development of industrial systems incorporating high-temperature electrolysers involves an increase in the volume of gas treated (in SOEC or SOFC). To do so, the increase in the surface area, the number of cells and of interconnectors, is necessary. Yet, a significant increase in the number of plates and therefore in the height of the stacks poses numerous technical difficulties, in particular during the manufacturing phases. Indeed, the larger the height of the stacks, the greater the amplitude of the shrinkage during the conditioning phase and the more critical the control of the guidance will be.

In current designs, this guidance is ensured by cylindrical columns positioned inside the structure of the stack passing through the different plates in which cylindrical or oblong holes are machined tightly matching the diameter of the columns. The base of these columns is mechanically blocked in the lower end plate.

This type of device has various limitations related to the small diameters of the guiding columns imposed by the inner structure of the interconnectors. Obtaining a satisfactory guidance of numerous thin plates over large heights by this type of columns involves a fine control of the relative clearances between the columns and the diameters of the passage holes. This type of assembly with tight clearances exposes to the risk of off-centring upon rotation which might occur during the cycle of formation of the sealing vitroceramic, during which the stack experiences a significant shrinkage of its height. It should be noted that the force applied to ensure the contact of the different plates is not so great, and therefore any inadvertent jamming of the plates with respect to their guiding elements is problematic.

For illustration, FIGS. 3A and 3B show the current guiding solution. Two columns 11 and 12 are used to guide the plates P of the stack 20 (herein shown very schematically) in their descent. The plates P may consist of interconnection plates, insulating plates, or the lower and upper end plates. In this case, in FIG. 3B, two interconnection plates P are considered, for example, the other possible interconnection and insulating plates and the lower and upper end plates are therefore not shown.

On one side, an orifice O1 with circular-shaped section is used, and the adjustment between the plate P and the column 11 is very fine, for example with a clearance J1 in the range of 0.1 mm. On the other side, the orifice O2 in the plate P has an oblong shaped section, leaving a larger clearance J2. Then, pressing at the centre to make the plates P descend, like according to the arrows F, as the vitroceramic seals are melted, might cause a slight bending of these plates P, and thus cause blocking by off-centring, represented by AC in FIG. 3B, on the column 11 on which the adjustment is tightened. In practice, in order to avoid these risks of off-centring AC, the clearance J1 around the guiding column 11 can be considerably increased, which then fundamentally degrades the guidance function and is therefore undesirable.

Thus, there is a need to propose an effective guiding solution allowing avoiding this off-centring problem while preserving guiding accuracy during the shrinkage of the stack of plates.

### DISCLOSURE OF THE INVENTION

The invention aims to at least partially address the aforementioned needs and the drawbacks relating to the embodiments of the prior art.

Thus, an object of the invention, according to one of its aspect, is a stack of SOEC/SOFC-type solid-oxide cells operating at high temperature, consisting of a plurality of plates stacked on top of one another according to a vertical direction substantially perpendicular to each horizontal plane of extent of each plate, said plurality of plates including at least:
a plurality of electrochemical cells each formed of a cathode, an anode and an electrolyte interposed between the cathode and the anode, and a plurality of interconnectors each arranged between two adjacent electrochemical cells,
an upper end plate and a lower end plate, between which the plurality of electrochemical cells and the plurality of interconnectors are sandwiched, said stack further including at least two guiding elements ensuring guidance of at least part of the plates into a vertical stacking, each plate of said at least part of the plates including at least two guiding orifices each opening onto the upper and lower faces of each plate and enabling passage of said at least two guiding elements, characterised in that, when observed in section in a horizontal plane of extent of each plate of said at least part of the plates, said at least two guiding orifices are aligned according to a first horizontal direction and spaced apart by a smallest inter-orifice distance, said at least two guiding elements being spaced apart by a smallest inter-element distance larger than the smallest inter-orifice distance, the difference between the smallest inter-element distance and the smallest inter-orifice distance, corresponding to the inner clearance, being identical for said at least two guiding orifices and said at least two guiding elements, in that, according to the first horizontal direction, said at least two guiding orifices are spaced apart by a largest inter-orifice distance, said at least two guiding elements being spaced apart by a largest inter-orifice distance smaller than the largest inter-orifice distance, the difference between the largest inter-orifice distance and the largest inter-element distance, corresponding to the outer clearance, and in that the outer clearance is larger than the inner clearance.

The stack according to the invention may further include one or more of the following features considered separately or according to any technical-feasible combination.

Advantageously, the inner clearance is larger than 0, in particular larger than 0.6 μm, and in particular comprised between 1 μm and 100 μm.

Advantageously, the outer clearance is larger than the inner clearance, and in particular comprised between 0.5 mm and 3 mm.

The ratio between the outer clearance and the inner clearance may be greater than 30, in particular comprised between 30 and 500.

The value of the inner clearance and/or of the outer clearance may depend on the thickness of the plate(s), and also on the possible, or tolerated, inclination of these, by local solid body movement or by deformation, in particular in bending. Also, the level of pressing force and the rigidity of the plates are involved in the determination of this value.

In addition, the outer clearance may be identical for said at least two guiding orifices and said at least two guiding elements.

Said at least two guiding orifices may have the same shape and the same dimensions.

Moreover, said at least two guiding orifices have, in section, an oblong shape, or a circular shape, or a polygonal shape, in particular a square or rectangular shape, in particular with at least the angle the closest to the centre of the plate forming an angle different from 90°, in particular larger than 90°.

Furthermore, each plate of said at least part of the plates is square or rectangular shaped. Said at least two guiding orifices may be diagonally opposite.

Said at least two guiding elements may consist of guiding rods having a cylindrical shape, and in particular having a circular shape in section.

Moreover, when observed in section in a horizontal plane of extent of each plate of said at least part of the plates, the largest guiding orifice dimension of each guiding orifice, according to a second horizontal direction perpendicular to the first horizontal direction, may be larger than the largest guiding element dimension of each guiding element, measured according to the second horizontal direction.

In addition, the ratio between the largest guiding orifice dimension and the largest guiding element dimension, measured according to the second horizontal direction, may be comprised between 1 and 3. This ratio may be determined according to various parameters such as the plate thickness, the plate stiffness, the possible plate inclination, inter alia. This determination is done by mechanical calculation with the geometric criterion of ensuring the existence of a functional clearance, while taking account of the movements of the solid bodies of the mechanical elements as well as any deformation thereof.

Furthermore, another object of the invention, according to another aspect thereof, is a method for packaging a stack of SOEC/SOFC-type solid-oxide cells operating at high temperature as defined before, characterised in that it includes the step of guiding into a vertical stacking at least part of the plates making up the stack by means of said at least two guiding elements.

The guiding step may be implemented while preserving a substantially constant gap between said at least two guiding elements and said at least two guiding orifices.

In addition, said at least two guiding elements being fixed in a packaging base, the method may include the step of using the same coefficients of thermal expansion for the materials of the plates and of the conditioning base.

In particular, the materials used for the plates and the packaging base may be identical in order to have the same coefficient of thermal expansion or different but with the same coefficient of thermal expansion.

### BRIEF DESCRIPTION OF THE DRAWINGS

The invention could be better understood upon reading the following detailed description of non-limiting examples of implementation of the latter, as well as upon examining the schematic and partial figures of the appended drawing, wherein:

FIG. 1 is a schematic view showing the operating principle of a high-temperature solid-oxide electrolyser (SOEC),

FIG. 2 is an exploded schematic view of a portion of a high-temperature solid-oxide electrolyser (SOEC) comprising interconnectors according to the prior art,

FIG. 3A and FIG. 3 Bshow, schematically and partially, respectively according to a top view and according to a side view, a principle according to the prior art for guiding the plates of a SOEC/SOFC-type high-temperature stack,

FIG. 4A and FIG. 4 Bshow, schematically and partially, respectively according to a top view and according to a side view, an example in accordance with the invention for guiding the plates of a SOEC/SOFC-type high-temperature stack,

FIG. 4C and FIG. 4 Dare respectively enlarged views according to C and D of FIG. 4A,

FIG. 5 Ashows, schematically and partially, according to a top view, another example in accordance with the invention for guiding the plates of a SOEC/SOFC-type high-temperature stack,

FIG. 5B is an enlarged view according to B1 of FIG. 5A,

FIG. 6A shows, schematically and partially, according to a top view, still another example in accordance with the invention for guiding the plates of a SOEC/SOFC-type high-temperature stack, and

FIG. 6B is an enlarged view according to B1 of FIG. 6A.

In all these figures, identical references may designate identical or similar elements.

In addition, the different portions shown in the figures are not necessarily plotted according to a uniform scale, to make the figures more readable.

### DETAILED DISCLOSURE OF PARTICULAR EMBODIMENTS

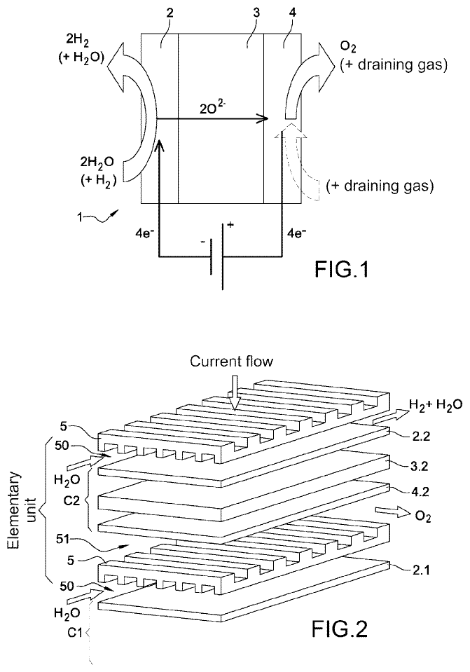

FIGS. 1 to 3 have already been described before in the part relating to the prior art and to the technical context of the invention. It is specified that, for FIGS. 1 and 2, the symbols and the arrows for steam supply H₂O, for distribution and recovery of dihydrogen H₂, oxygen O₂, air and electric current, are shown for clarity and accuracy purposes, to illustrate the operation of the shown devices.

Furthermore, it should be noted that all of the constituents (anode/electrolyte/cathode) of a given electrochemical cell are preferably ceramics.

Moreover, the operating temperature of a SOEC/SOFC-type high-temperature stack is typically comprised between 600 and 1,000° C.

In addition, any terms “upper”, “lower”, “horizontal” and “vertical” should be understood herein according to the common direction of orientation of a SOEC/SOFC-type stack when in its use configuration.

FIGS. 4A to 6B allow illustrating the guidance principle in accordance with the invention.

First of all, FIGS. 4A to 4D show a first possibility for guiding into a stack the plates P of a stack 20 of SOEC/SOFC-type high-temperature solid-oxide cells, the plates P being positioned on top of one another according to a vertical direction substantially perpendicular to each horizontal plane of extent of each plate P.

It should be noted that, in all of the examples described herein, a plate P may correspond in particular to an electrochemical cell C1, C2, an interconnector 5, an upper end plate or a lower end plate, or an insulator plate. Preferably, the plate P will generally be an interconnector 5.

Guidance into a vertical stacking is carried out using two guiding elements 11 and 12, herein in the form of guiding rods or columns. These guiding columns 11, 12 are herein diagonally spaced apart on each square-shaped plate P, but this choice is not restrictive.

In addition, each plate P includes two guiding orifices O1 and O2 each opening onto the upper face FS and the lower face FI of each plate P. These guiding orifices O1, O2 enable passage of the guiding columns 11, 12. They are also diagonally spaced apart herein on each plate P, but this choice is not restrictive.

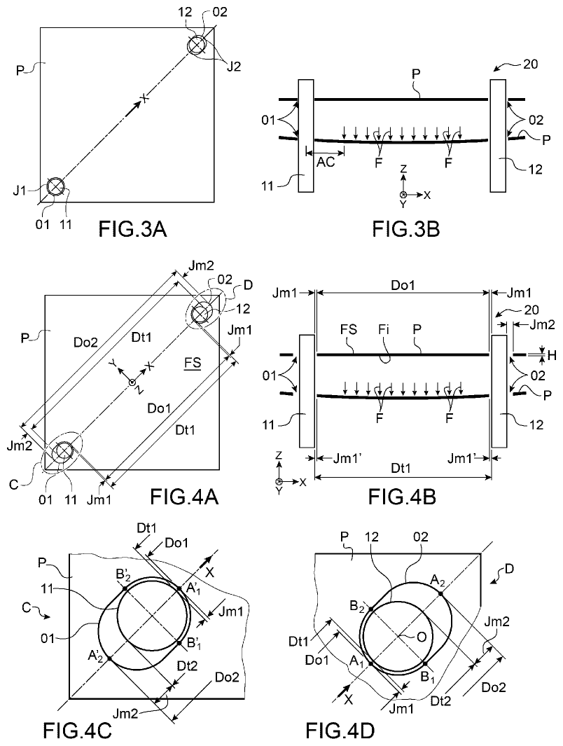

When carrying out packaging of the stack 20, a vertical compressive force is applied on the latter. This force is generally located between the guiding columns 11, 12, which could cause bending of the plates P which are stacked, as schematised by the arrows F in FIG. 3B and herein in FIG. 4B. In case of contact of the plates P with the columns 11, 12, as schematised before in FIG. 3B, an undesirable off-centring phenomenon of AC might occur.

The configuration proposed in accordance with the invention in FIGS. 4A to 4D is such that, when observed in section in a horizontal plane of extent of each plate P, the guiding orifices O1, O2 are aligned according to a first horizontal direction X and spaced apart by a smallest inter-orifice distance Do1. In addition, the guiding columns 11, 12 are spaced apart by a smallest inter-element distance Dt1 which is larger than the smallest inter-orifice distance Do1.

The difference between the smallest inter-element distance Dt1 and the smallest inter-orifice distance Do1 corresponds to the inner clearance Jm1. This inner clearance Jm1 is identical at the level of each pair O1, 11 and O2, 12 of guiding orifice and guiding column.

Moreover, still according to the first horizontal direction X, the guiding orifices O1, O2 are spaced apart by a largest inter-orifice distance Do2, and the guiding columns 11, 12 are spaced apart by a largest inter-element distance Dt2 which is smaller than the largest inter-orifice distance Do2.

The difference between the largest inter-orifice distance Do2 and the largest inter-element distance Dt2 corresponds to the outer clearance Jm2. Advantageously, this outer clearance Jm2 is larger than the inner clearance Jm1.

Consequently, bending of a plate P, as schematised by the arrows F in FIG. 4B, will herein be in the direction of facilitating the vertical descent of the latter. Indeed, during bending, the smallest inter-orifice distance Do1, measured according to the first horizontal direction X, namely the distance between the points A₁ and A₁′, will decrease because of bending of the plate P, which will tend to free the vertical movement of the plate P because the smallest inter-element distance Dt1, always measured according to the first horizontal distance X, between the two columns 11 and 12 remains constant. Thus, the obtained inner clearance Jm1′ (cf. FIG. 4B) will increase in comparison with the clearance Jm1.

Similarly, the largest inter-orifice distance Do2, namely the distance between the points A₂ and A₂′, will also decrease upon bending, as shown in FIG. 4B. However, because of the presence of an outer clearance Jm2 much larger than the inner clearance Jm1, and because the largest inter-element distance Dt2 does not vary, there will be no contact between the plate P and the columns 11, 12, and therefore no jamming or off-centring phenomenon.

In order to avoid any blockage of the plate P on the columns 11, 12, the inner clearance Jm1 may be comprised between 1 μm and 100 μm.

Similarly, the outer clearance J2 may be comprised between 0.5 mm and 3 mm.

In particular, for a smallest inter-orifice distance Do1 in the range of 300 mm and a plate height H in the range of 0.6 mm, the clearance Jm1 may be larger than 0.6 am to avoid any blockage in a local solid body movement of the plate P. This corresponds to a very small clearance value and therefore enables a very accurate guidance, and thus positioning, of the plate P with respect to the guiding columns 11, 12.

Advantageously, it should also be noted that the outer clearance J2 is identical for the two guiding orifices O1, O2 and the two guiding columns 11, 12.

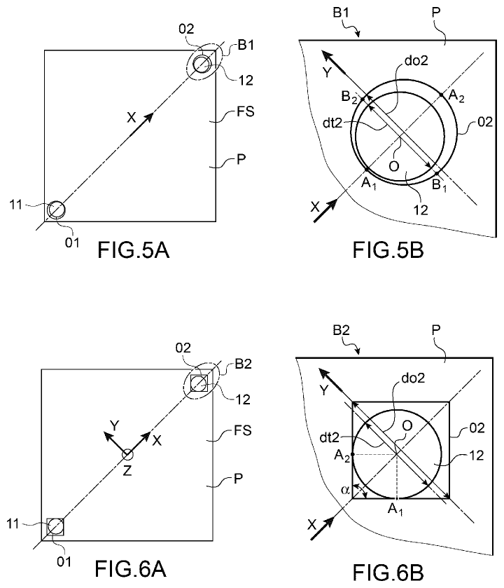

Moreover, in this example of FIGS. 4A to 4B, each of the guiding orifices O1, O2 has, in section, an oblong shape. In this case, the ratio of dimensions between the largest dimension of the guiding orifice do2 of each guiding orifice O1, O2, according to a second horizontal direction Y perpendicular to the first horizontal direction X, namely the distance between the points B₁ and B₂ or between the points B₁′ and B₂′ in the example of FIGS. 4C and 4D, and the largest guiding element dimension dt2 of each guiding element 11, 12, measured according to the second horizontal direction Y, namely herein the diameter passing through the centre O of the columns 11, 12, as shown in FIGS. 5B and 6B for example, may be too close to 1. In other words, the distances B₁B₂ and B₁′B₂′ may be substantially equal to the diameter of the columns 11, 12.

Then, in case of rotation of the plate P according to the first horizontal direction X, there might be an off-centring at the points B₁, B₁′, B₂ and B₂′ of the oblong shape (cf.

FIGS. 4C and 4D). In order to avoid this phenomenon, another configuration in accordance with the invention may be proposed.

Thus, in the example of FIGS. 5A and 5B, the guiding orifices O1, O2 correspond to cylinders whose circular shape in section is larger than that of the columns 11, 12. In other words, the diameter of each guiding orifice O1, O2 is larger than the diameter of each guiding column 11, 12. The guiding orifices O1, O2 are eccentric with respect to the guiding columns 11, 12.

A tight fit is preserved at the points A₁ and A₁′ but the clearances are now larger at the points B₁, B₂, B₁′ and B₂′.

Specifically, the largest guiding orifice dimension do2 of each guiding orifice O1, O2, according to the second horizontal direction Y, different herein in the example of FIGS. 5A and 5b of the distance B₁B₂ or B₁′B₂′, is larger than the largest guiding element dimension dt2 of each guiding column 11, 12, namely herein its diameter passing through the centre O.

Advantageously, the ratio between the largest guiding orifice dimension do2 and the largest guiding element dimension dt2, measured according to the second horizontal direction Y, is comprised between 1 and 3.

A third possible configuration of the invention, illustrated in FIGS. 6A and 6B, consists in using guiding orifices 11, 12 with a substantially square shape, larger, and eccentric with respect to the position of the columns 11, 12.

This configuration describes a principle similar to that of FIGS. 5A and 5B. However, it uses herein “V-like shaped contacts (A₁, O, A₂), as shown in FIG. 6B.

This configuration prevents rotation according to a third vertical direction Z, and still preserves the advantage that the distances A₁A₁′ or A₂A₂′ are reduced thereby avoiding any contact between the plate P and the column 11, 12 during stacking vertically downwards during the process of packaging the stack 20. Hence, any off-centring problem is avoided. The angle α the closest to the centre of the plate P, namely the angle α of the two contact planes, may be variable. Advantageously, it is selected so as to be different from 90°, in particular larger than this value so as to allow for a little more possibility of rotation according to the directions X and Z.

During the process of packaging such a stack 20, a substantially constant difference should be preserved between the guiding columns 11, 12 and the guiding orifices O1, O2, in particular during the temperature rise. This difference should be able to remain larger than 0. In order to guarantee this, the thermal expansions governing both the size of the columns 11, 12 and the size of the plates P should be balanced, in particular by a judicious choice of the coefficients of thermal expansion of the used materials, and a temperature field that is as homogeneous as possible over the entire assembly.

Advantageously, the guiding columns 11, 12 will be fastened in a packaging base and one or more same material(s) will be used for the plates P and for the conditioning base in order to obtain the same coefficients of thermal expansion.

The invention finds a main application thereof for the assembly of SOEC/SOFC-type high-temperature stacks. In particular, the invention is applicable during the conditioning phase, during which phase the size of the stack decreases considerably because of melting of the glass joints of the assembly as described before in the part relating to the prior art and to the technical context of the invention.

Of course, the invention is not limited to the embodiments that have just been described. Various modifications may be made thereto by a person skilled in the art.

1. A stack of SOEC/SOFC-type solid-oxide cells operating at high temperature, consisting of a plurality of plates stacked on top of one another according to a vertical direction substantially perpendicular to each horizontal plane of extent of each plate, the plurality of plates comprising:
a plurality of electrochemical cells each formed of a cathode, an anode and an electrolyte interposed between the cathode and the anode,
a plurality of interconnectors each arranged between two adjacent ones of the electrochemical cells, and
an upper end plate and a lower end plate, between which the plurality of electrochemical cells and the plurality of interconnectors are sandwiched,
said stack further comprising at least two guiding elements configured to guide at least part of the plates into a vertical stacking,
each plate of the at least part of the plates including at least two guiding orifices each opening onto upper and lower faces of each plate and configured to allow passage of the at least two guiding elements, wherein
when observed in section in a horizontal plane of extent of each plate of the at least part of the plates, the at least two guiding orifices are aligned according to a first horizontal direction and spaced apart by a smallest inter-orifice distance, the at least two guiding elements being spaced apart by a smallest inter-element distance larger than the smallest inter-orifice distance, and a difference between the smallest inter-element distance and the smallest inter-orifice distance corresponding to an inner clearance being identical for the at least two guiding orifices and the at least two guiding elements,
according to the first horizontal direction, the at least two guiding orifices are spaced apart by a largest inter-orifice distance, the at least two guiding elements being spaced apart by a largest inter-element distance smaller than the largest inter-orifice distance, and a difference between the largest inter-orifice distance and the largest inter-element distance, corresponding to an outer clearance, and
the outer clearance is larger than the inner clearance.

2. The stack according to claim 1, wherein the inner clearance is comprised between 1 μm and 100 μm.

3. The stack according to claim 1, wherein the outer clearance is comprised between 0.5 mm and 3 mm.

4. The stack according to claim 1, wherein the outer clearance is identical for the at least two guiding orifices and the at least two guiding elements.

5. The stack according to claim 1, wherein the at least two guiding orifices have a same shape and dimensions.

6. The stack according to claim 5, wherein the at least two guiding orifices have, in section, an oblong shape.

7. The stack according to claim 6, wherein the at least two guiding orifices have, in section, a circular shape.

8. The stack according to claim 6, wherein the at least two guiding orifices have, in section, a polygonal shape.

9. The stack according to claim 1, wherein each plate of the at least part of the plates is square or rectangular shaped and the at least two guiding orifices are diagonally opposite.

10. The stack according to claim 1, wherein the at least two guiding elements are guiding rods having a cylindrical shape.

11. The stack according to claim 1, wherein, when observed in section in a horizontal plane of extent of each plate of the at least part of the plates, a largest guiding orifice dimension of each guiding orifice, according to a second horizontal direction perpendicular to the first horizontal direction, is larger than a largest guiding element dimension of each guiding element, measured according to the second horizontal direction.

12. The stack according to claim 11, wherein a ratio between the largest guiding orifice dimension and the largest guiding element dimension, measured according to the second horizontal direction, is comprised between 1 and 3.

13. A method for packaging a stack of SOEC/SOFC-type solid-oxide cells operating at high temperature according to claim 1, comprising guiding into a vertical stacking at least part of the plates making up the stack using the at least two guiding elements.

14. The method according to claim 13, wherein the guiding comprises preserving a substantially constant gap between the at least two guiding elements and the at least two guiding orifices.

15. The method according to claim 13, wherein the at least two guiding elements are fixed in a packaging base, the method further comprising using materials having the same coefficients of thermal expansion for the plates and a conditioning base.

16. The stack according to claim 8, wherein the at least two guiding orifices have, in section, a square or rectangular shape.

17. The stack according to claim 8, wherein the at least two guiding orifices with the polygonal shape form an angle closest to a centre of the plate being different from 90°.
